(19) United States
(12) Patent Application Publication
(10) Pub. No.: US 2014/0182211 A1
(43) Pub. Date: Jul. 3, 2014

(54) SUPPORT FOR A ROLLING CLOSURE

(71) Applicants: Craig Cameron Lang, Eltham (AU); John David Saunders, Stafford (AU)

(72) Inventors: Craig Cameron Lang, Eltham (AU); John David Saunders, Stafford (AU)

(73) Assignee: MAMMOTH INDUSTRIES PTY LTD, Thomastown (AU)

(21) Appl. No.: 14/009,690

(22) PCT Filed: Apr. 5, 2012
(86) PCT No.: PCT/AU12/00344

§ 371 Date: Jan. 2, 2014

(30) Foreign Application Priority Data
May 4, 2011 (AU) 2011901254

(51) Int. Cl. E05D 15/06

(52) U.S. Cl. CPC E05D 15/0665; E05D 15/0686
USPC 49/420; 49/506; 16/107; 16/96 R

(57) ABSTRACT

A lower support for a rolling closure comprising:
a carriage for supporting a panel of the closure having
   at least one horizontal load wheel having an inclined rim, and
   at least one horizontal guide wheel,
wherein at least one of the wheels is adapted to be substantially enclosed within a track.

### FIELD OF INVENTION

The present invention relates to the field of supports for rolling closures including supports for sliding or folding doors or windows.

In one form, the invention relates to a lower support for a rolling closure comprising one panel, such as a sliding door, or two or more panels, such as those typically used in a folding door.

While it will be convenient to hereinafter describe the invention in relation to folding doors, it should be appreciated that the present invention is not limited to that use and can be applied to other closures including windows and partitions.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Rolling closures are well known and widely used in the construction industry for industrial, commercial and domestic premises for closing off an opening in an interior or exterior wall. These include for example, rolling closures in the form of single panel sliding doors or multi-panel folding doors.

Rolling closures typically include at least one panel that is suspended from one or more carriages (upper supports) that travel along an overhead track. The panel may also be supported at its base by carriages (lower supports) on a floor-level track.

The upper and lower supports and tracks must be constructed such that they are strong enough to support the load imparted by the weight of the panel(s), yet provide a smooth rolling motion along the track. It is also important that the rolling motion can be easily controlled, particularly if the closure is to be manually opened and closed.

Designing upper and lower supports that are appropriate for the weight of the panel in a rolling closure can be challenging. In the past, as panel weight increased designers included more and more wheels and increased the size of the upper support. Designers have also increased the sizes of wheels used—the larger the wheel, the greater the weight that can be supported and the smoother its rolling motion along the track. As a result it has also been necessary to increase the size of the track along which the wheels roll. However it is often not possible from an aesthetic, architectural or structural point of view to use a large upper support or large track.

The challenge of increasing panel weight has also been approached by changing the conformation of the carriage wheels. The conformation of the wheels has been changed, for example, by replacing radially mounted wheels with a combination of radial and laterally mounted wheels, or just laterally mounted wheels. Furthermore, the wheels are often provided with a taper at their rim, which decreases the contact area between the wheel and the track and promotes smoother rolling.

Another problem associated with rolling closures of the prior art is that lower supports (and to a lesser extent, the upper supports) are exposed to dirt and the elements, particularly rain. In particular, dirt can build up in the tracks and water retention can cause corrosion, preventing a smooth rolling motion. Increased maintenance is necessary to maintain smooth, easy operation of the panels, or the support and track lifespan may be significantly reduced. For this reason, weather seals are usually provided, for example, between the door panel(s) of a rolling closure and the door frame. The weather seals typically comprise a rubber fin or strip of polymer fibres and are located adjacent the upper and lower supports.

Nevertheless, most tracks of the prior art have a relatively open structure which readily traps dirt. This has prompted some manufacturers to use a carriage that includes a combination of radial and laterally mounted wheels which act to ‘plough’ out any dirt or debris which may collect in the track.

Accordingly, there is a need for improved supports for rolling closures which address some or all of the problems of the prior art.

### SUMMARY OF INVENTION

An object of the present invention is to provide a lower support for a rolling closure that can bear high panel loads.

A further object of the present invention is to provide a lower support for a rolling closure that resists dirt and moisture ingress.

A further object of the present invention is to provide a lower support for a rolling closure that has reduced maintenance requirements.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a lower support for a rolling closure comprising:
a carriage for supporting a panel of the closure, the carriage having
   at least one load wheel having an inclined rim, and
   at least one guide wheel,
wherein at least one of the wheels is adapted to be substantially enclosed within a track.

Preferably, both the load wheel(s) and guide wheel(s) are received and substantially enclosed within the track. In some embodiments of the lower support, the track in combination with the panel substantially encloses both the load wheel(s) and guide wheel(s).

Typically each panel of the closure is supported by at least one carriage. Two or more carriages may be required for particularly heavy panels, or panels that are to have the majority of their load on the lower support.

While the carriage may operate with one load wheel and one guide wheel, heavier panels may require two, three or even more load wheels and/or guide wheels. The carriage wheels are typically mounted on a wheel support, such as a flat plate.

Typically the load wheel(s) and/or the guide wheel(s) will be horizontal or slightly angled, for example up to about 45° from horizontal. The angle of the load wheel(s) and guide wheel(s) may be the same or different.

In a second aspect of embodiments described herein there is provided a track for a lower support of a rolling closure comprising;
a base in connection with a substantially vertical first side wall,
an upper wall in connection with the first side wall, and
a substantially vertical second side wall in connection with the upper wall, the base and walls defining a recess for receiving at least one wheel of a carriage.

In a particularly preferred embodiment the base and walls of the track form a generally C-shaped or G-shaped recess. For example, in one embodiment the second wall does not connect with the base, thus leaving an opening through which the wheel support of the carriage can project.

In this manner the wheels are substantially enclosed in the C-shaped or G-shaped recess and this contributes to protecting the wheels from dirt and the elements. It also conceals the carriage and its wheels from view to improve the aesthetics of the closure.

In a third aspect of embodiments described herein there is provided a system for supporting a rolling closure, the system comprising the aforementioned lower support in combination with the aforementioned track.

In a fourth aspect of embodiments described herein there is provided a method of supporting a rolling closure from its lower aspect, the method comprising,
providing a carriage having at least one load bearing wheel and at least one guide wheel,
providing at least one inclined surface, the inclined surface cooperating with at least one of the aforesaid wheels,
   wherein the angle between the plane of the at least one aforesaid wheel and the horizontal is up to 45°.

In a further aspect of embodiments described herein there is provided an apparatus when used to carry out the aforesaid method, the apparatus comprising;
a lower support for a panel, the lower support including a carriage having at least one load bearing wheel and at least one guide wheel,
a track including at least one inclined surface for cooperating with at least one of the aforesaid wheels,
   wherein the angle between the at least one aforesaid wheel and the horizontal is up to 45°.

It will be readily apparent to the person skilled in the art that the carriage can be configured in a number of ways, to achieve both horizontal (or slightly angled) running of the load wheel(s) and horizontal (or slightly angled) running of the guide wheel(s). Similarly, the track must be configured to maintain smooth running of the load wheel(s) and the guide wheel(s).

The lower support of the present invention will allow support of relatively heavy panels, thus reducing the load on the upper support. In some cases, the upper support may only be required as a guide for the upper edge of the closure panels, to hold them and to ensure the panels are kept vertical.

The carriage wheels, particularly the load wheel(s) typically include an inclined rim, to minimise the surface area on which the wheel rolls. The inclined rim of the load wheel preferably tapers by 4 to 5 ° from horizontal.

In a particularly preferred embodiment, the track includes one or more inclined surfaces for receiving a rim of a carriage wheel. Typically the inclined surface is located adjacent the connection between the base and first side wall. Alternatively the inclined surface(s) may be associated with the second side wall. Typically the incline is approximately 4 to 7°, or more preferably 5 to 6° upwards or downwards from horizontal. The combination of the incline on the load wheel rim and the track surface tends to force the load wheel away from the side walls of the track. Ordinarily this would change the direction of motion of the load wheels if not for the provision of the guide wheel.

The track may be mounted to a lower surface (such as a floor in the case of a door closure, or a window sill in the case of a window closure). The track may be flush mounted to the lower surface or recessed for a flush fit. In a particularly preferred embodiment the base of the track or its upper surface is inclined so that any water in the track will drain down the incline.

In a further aspect of embodiments described herein there is provided a rolling closure comprising at least one panel and either the lower support, or the track, or the combination of lower support and track as herein described.

The rolling closure of the present invention is typically used as a door or window for an opening in a structure such as a wall. The closure may comprise a single panel, or multiple panels such as in a folding closure.

For smaller openings, typically a single closure will be sufficient. Larger openings may have two closure systems which converge from opposite directions. In one preferred embodiment, both closure systems are constructed to include the lower support or track of the present invention. Alternatively, one of the closure systems is constructed according to the present invention and the other closure system is of a construction known in the prior art.

In another aspect of embodiments described herein there is provided a method of installing a folding closure system in an opening comprising the steps of (i) installing a track according to the present invention, and (ii) locating within the trace a lower support according to the present invention.

Other aspects and preferred forms are disclosed in the specification and/or defined in the appended claims, forming a part of the description of the invention.

In essence, embodiments of the present invention stem from the realization that it is possible to use a horizontal (or slightly angled) load wheel in a lower support) when combined with a guide wheel to achieve smooth, straight bottom supported rolling of a closure.

Advantages provided by the present invention comprise the following:
Improved aesthetics of a rolling closure by increasing options for installation of the lower support;
Reduced maintenance requirements for the closure;
Reduced exposure of the lower support to the elements including reduces dirt and moisture ingress;
Self draining of the lower support to expel water and moisture build-up;
Ability to increase the load borne by the lower support, or the upper and lower support in combination;
Reduction of the load borne by the upper support, and thus avoiding the need for increased size of the upper support.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 is a view of an edge of a panel of a folding closure of the prior art showing the upper and lower supports and their corresponding tracks;

FIG. 2 is an end view of an upper support according to the prior art having horizontal (lateral) wheels;

FIG. 3 is a cross-sectional plan view of a lower support and track according to one embodiment of the present invention; and

FIG. 4(a) is a cross-sectional plan view of the lower support and track of FIG. 3; and FIG. 4(b) is a view in the direction AA′ of FIG. 4(a);

FIG. 5 is a cross-sectional plan view of a lower support and track according to a further embodiment of the present invention;

FIG. 6(a) is a cross-sectional plan view of a lower support and track according to a further embodiment of the present invention; and FIG. 6(b) is a view in the direction BB′ of FIG. 6(a);

FIG. 7 includes illustrations of a lower support and track according to a further embodiment of the present invention; FIG. 7(a) is a front view of the carriage; FIG. 7(b) is a side view of the carriage of FIG. 7(a); FIG. 7(c) is a top view of the carriage of FIG. 7(a); FIG. 7(d) is a perspective view of the lower support including the carriage, and track in position at the edge of a door panel; FIG. 7(e) is a side view of the lower support, track and door panel of FIG. 7(d); and FIG. 7(f) is a detailed view of the lower support of FIG. 7(e);

FIG. 8 includes illustrations of a lower support and track according to a further embodiment of the present invention; FIG. 8(a) is a front view of the carriage; FIG. 8(b) is a side view of the carriage of FIG. 8(a); FIG. 8(c) is a top view of the carriage of FIG. 8(a); FIG. 8(d) is a perspective view of two door panels fitted to a track; FIG. 8(e) is a side view of the lower support, track and door panel of FIG. 8(d); and FIG. 8(f) is a detailed view of the lower support of FIG. 8(e); FIG. 8(g) is a perspective view of the lower support including the carriage, and track in position at the edge of a door panel;

FIG. 9 includes illustrations of a lower support and track according to a further embodiment of the present invention; FIG. 9(a) is a front view of the carriage; FIG. 9(b) is a side view of the carriage of FIG. 9(a); FIG. 9(c) is a top view of the carriage of FIG. 9(a); FIG. 9(d) is a perspective view of the carriage of FIG. 9(a); FIG. 9(e) is a perspective view of two door panels fitted to a track; FIG. 9(f) is a side view of the lower support, track and door panel; FIG. 9(g) is a detailed view of the lower support of FIG. 9(f); FIG. 9(h) is a perspective view of the lower support including the carriage, and track in position at the edge of a door panel;

FIG. 10 includes illustrations of a lower support and track according to a further embodiment of the present invention; FIG. 10(a) is a front view of the carriage; FIG. 10(b) is a side view of the carriage of FIG. 10(a); FIG. 10(c) is a top view of the carriage of FIG. 10(a); FIG. 10(d) is a perspective view of two door panels fitted to a track; FIG. 10(e) is a side view of the lower support, track and door panel of FIG. 10(d); and FIG. 10(f) is a detailed view of the lower support of FIG. 10(e); FIG. 10(g) is a perspective view of the lower support including the carriage, and track in position at the edge of a door panel;

FIG. 11 includes illustrations of a lower support and track according to a further embodiment of the present invention; FIG. 11(a) is a perspective view of the lower support in combination with a lower hinge; FIG. 11(b) is a side view of the lower support and lower hinge of FIG. 11(a) in combination with a track; FIG. 11(c) is a side plan view of the lower support, hinge and track of FIG. 11(b); FIG. 11(d) is a further perspective view of the lower support and lower hinge of FIG. 11(a); FIG. 11(e) is a view in the direction of CC′ of FIG. 11(d).

FIG. 12 includes illustrations of a lower support and track according to a further embodiment of the present invention in which the load and guide wheels are angled; FIG. 12(a) is a front view of the carriage; FIG. 12(b) is a side view of the carriage of FIG. 12(a) showing the angle of the carriage wheels; FIG. 12(c) is a perspective view of the carriage of FIG. 12(b); FIG. 12(d) is a top view of the carriage of FIG. 12(b); FIG. 12(e) is a perspective view of the lower support, track and door panel; and FIG. 12(f) is a side view of the lower support including the carriage, and track in position at the edge of a door panel;

### DETAILED DESCRIPTION

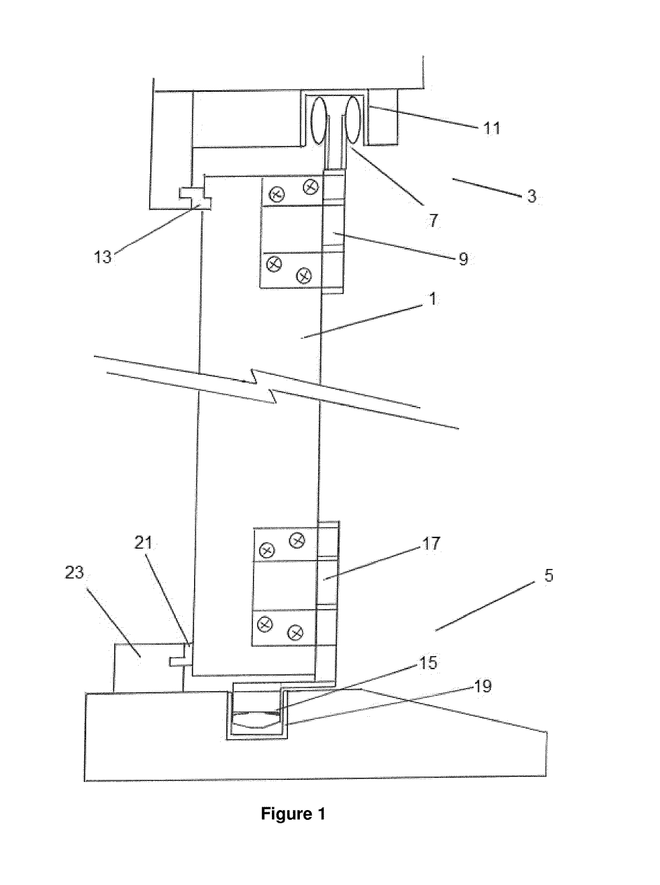

FIG. 1 is a view of an edge of one panel (1) of a bi-fold closure of the prior art. In this view can be seen the upper support (3) and the lower support (5). The upper support (3) comprises two radially (vertical) wheels (7) mounted on an upper hinge (9). The wheels are received within the top track (11). An upper weather seal (13) is located adjacent the head gap at the top of the panel (1) to hinder dirt and moisture ingress. The lower support (5) comprises a lateral (horizontal) wheel (15) mounted on a lower hinge (17). The wheel (15) is received within the lower track (19). A lower weather seal (21) is located between the sill (23) and the panel (1) to hinder dirt and moisture ingress.

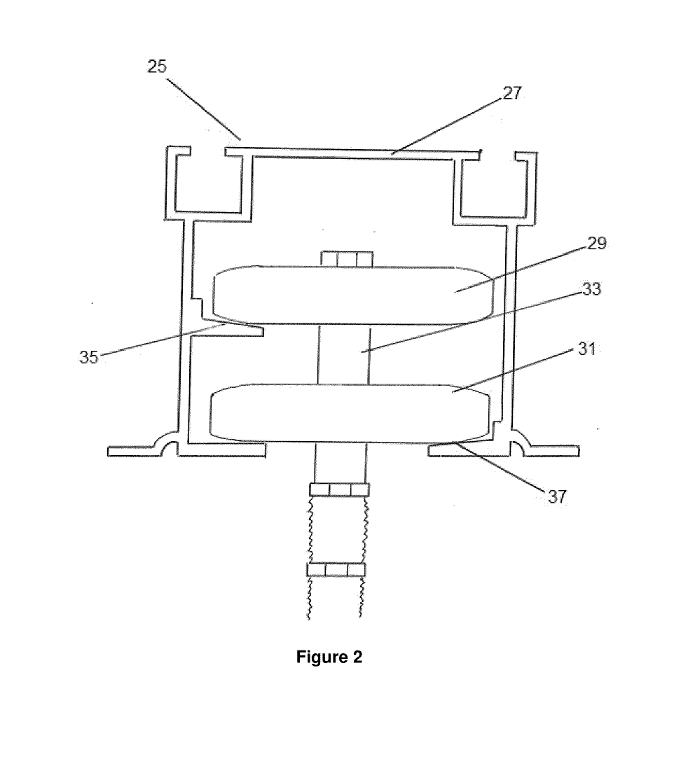

FIG. 2 is an end view of a prior art upper support (25) and metal track (27) for a top hung folding door. The upper support (25) has two horizontal (lateral) wheels (29, 31) which rotate about a central spindle (33). The central spindle (33) is typically fitted to the upper hinge of a door panel (not shown). The rim of each wheel (29, 31) is inclined by approximately 5° to the horizontal. Furthermore the inclined rim of each wheel rests on the track (27) at an inclined shoulder (35, 37).

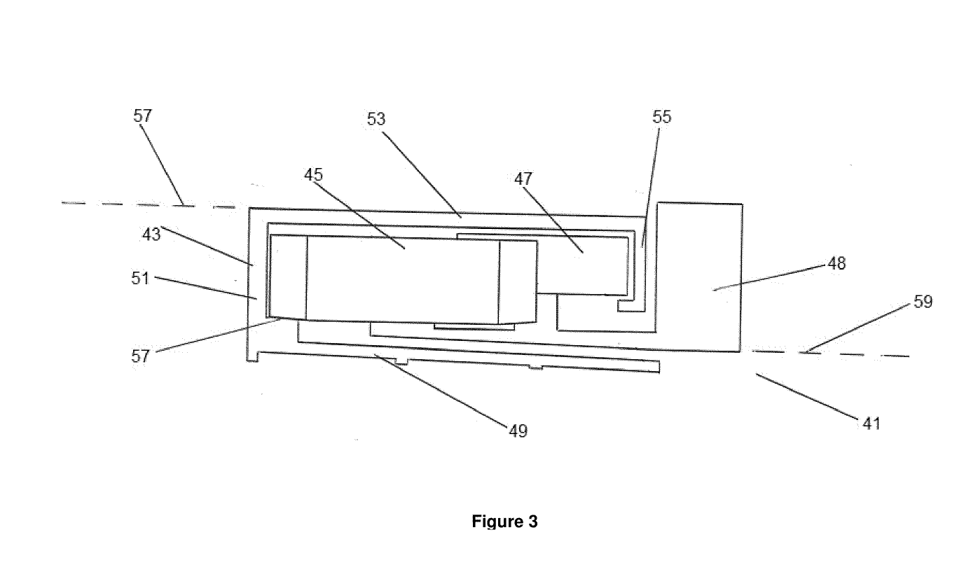

FIG. 3 is a cross-sectional plan view of a lower support (41) including a carriage (48) and track (43) according to one embodiment of the present invention. In this view can be seen one of the two horizontal load wheels (45) (the other load wheel (46) being located out of view) and the horizontal guide wheel (47) forming part of the carriage (48) which in use would attach to the lower edge or lower hinge of a door panel (not shown). The rim of each load wheel (49, 50) is inclined by approximately 5°. The track consists of a base (49) which connects to a substantially vertical first side wall (51). The first side wall (51) is in connection with an upper wall (53) which in turn is in connection with a second side wall (55). Thus the base (49) and walls (51, 53, 55) have a generally c-shaped cross section and define a recess for receiving the horizontal load wheels (49, 50) and the guide wheel (47). Adjacent the connection between the base (49) and first side wall (51) is a surface (57) inclined downwards from the horizontal by about 5° and the inclined rim of the load wheel (45) rests upon this surface (57).

The conformation of the track (43) is such that it defines a recess and substantially encloses the load wheels (49, 50) and the guide wheel (47), thus protecting them from dirt and water ingress. This is substantially more effective than tracks of the prior art which typically have a more open structure and must rely on weather seals between the door panels and door frame. Furthermore, the base (49) of the lower support shown in FIG. 2 is not parallel to the upper wall (53), but declines by a few degrees from the horizontal. Should any water make its way into the track (43) the incline will act to drain away the water. In addition, the carriage (48) itself forms a barrier to dirt or water entering the opening of the track (43).

FIG. 3 depicts the track (43) as being set relative to the interior floor level (broken line 57) and an exterior floor/ground level (broken line 59). Because the wheels are in a horizontal orientation, this significantly reduces the necessary height of the track, typically to between 3 cm and about 8 cm.

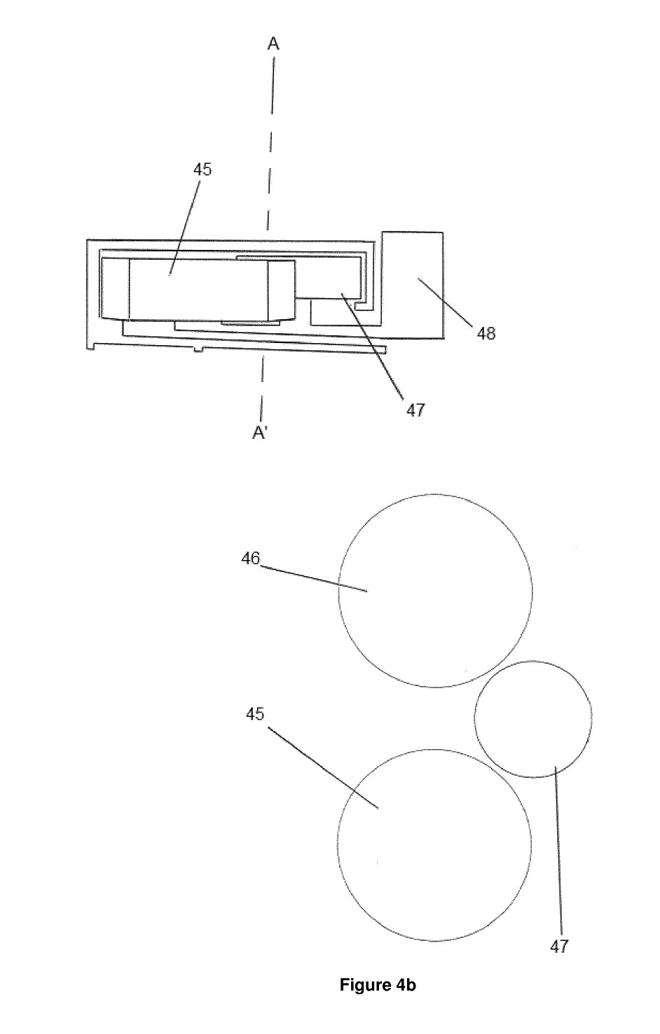

FIG. 4(a) is a cross-sectional plan view of the lower support (41) depicted in FIG. 3. FIG. 4(b) is a view along AA′ of FIG. 4(a) to show the relative positions of the load wheels (45, 46) and the guide wheel (47).

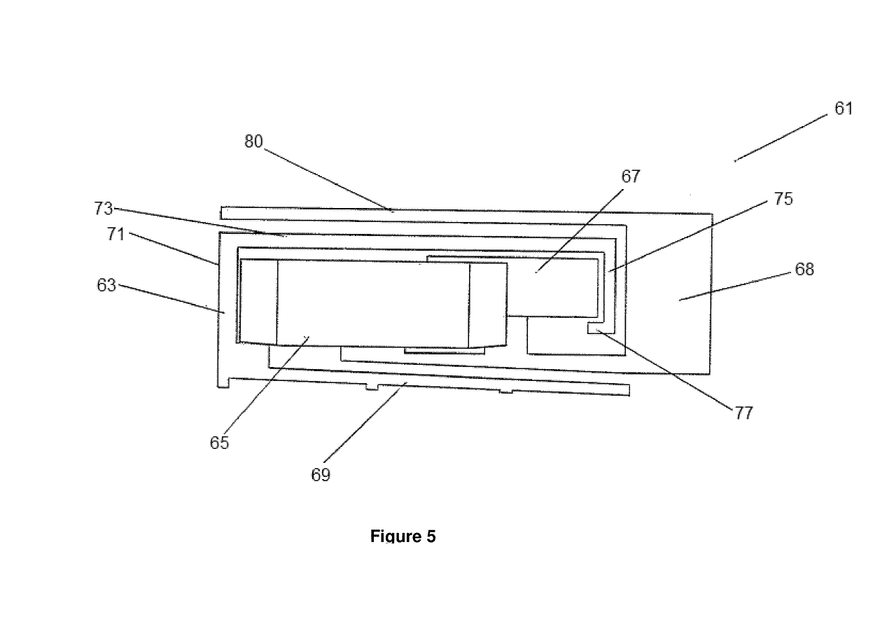

FIG. 5 is a cross-sectional plan view of a lower support (61) including a carriage (68) and track (63) according to one embodiment of the present invention. In this view can be seen one of the two horizontal load wheels (65) (the other load wheel (66) being located out of view) and the horizontal guide wheel (67) forming part of the carriage (68). The carriage (68) of this embodiment of the lower support (61) differs from the carriage (48) depicted in FIG. 3, which would typically be attached to the lower hinge of a door panel. In this embodiment the carriage (68) includes an upper flat surface or plate (80) and the edge of the door or hinge could be located at any convenient position along this plate.

The track consists of a base (69) which connects to a substantially vertical first side wall (71). The first side wall (71) is in connection with an upper wall (73) which in turn is in connection with a second side wall (75). The second side wall (75) includes a small shoulder or flange (77) which is useful for assembly of the lower support (61), but not essential for its operation. Thus the base (69) and walls (71, 73, 75) have a generally c-shaped cross section and define a recess for receiving the horizontal load wheels (89, 70) and the guide wheel (67).

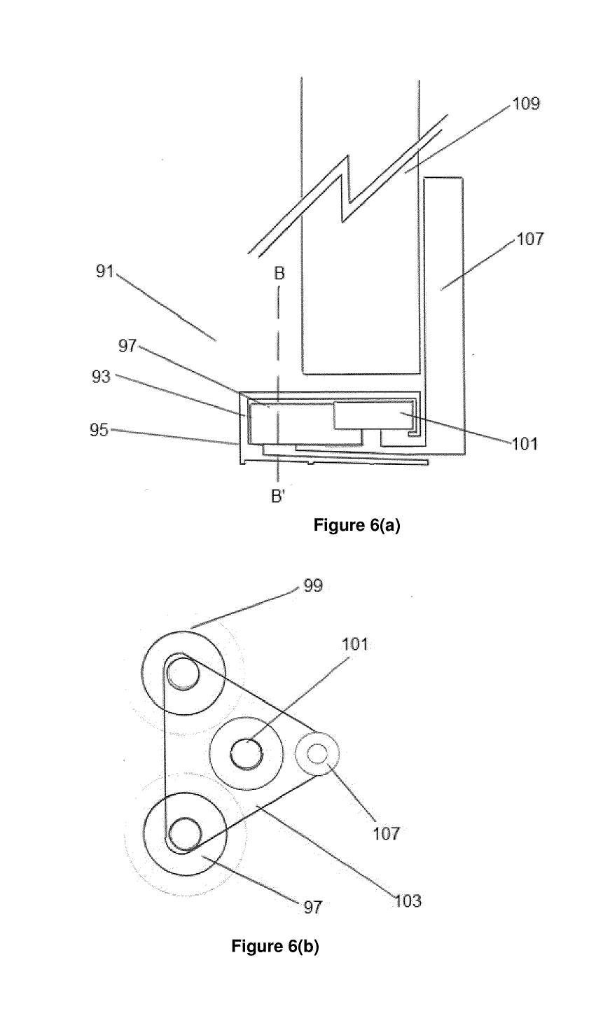

FIG. 6 is a cross-sectional plan view of a lower support (91) including a carriage (93) and track (95) according to one embodiment of the present invention. The carriage includes two horizontal load wheels (97) (the other load wheel (99) being located out of view) and the horizontal guide wheel (101) supported on a plate (103) which connects with a vertical support (107). The vertical support (107) would typically form part of a lower hinge or other door accessory for a panel (109) of a rolling closure.

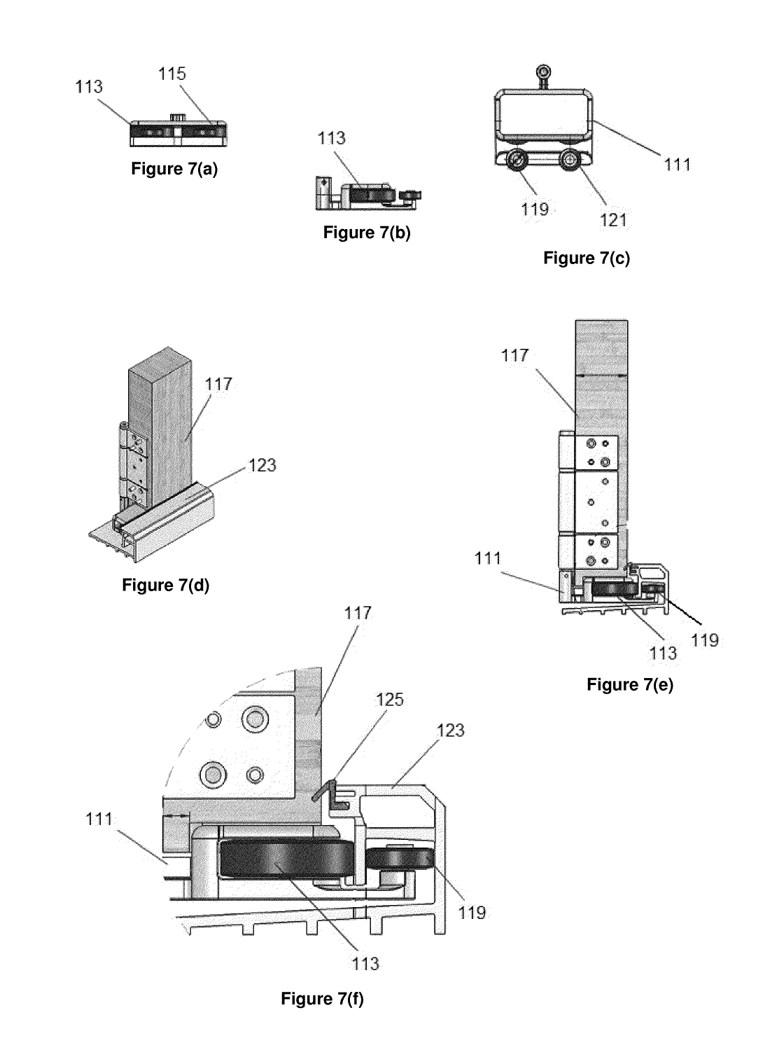

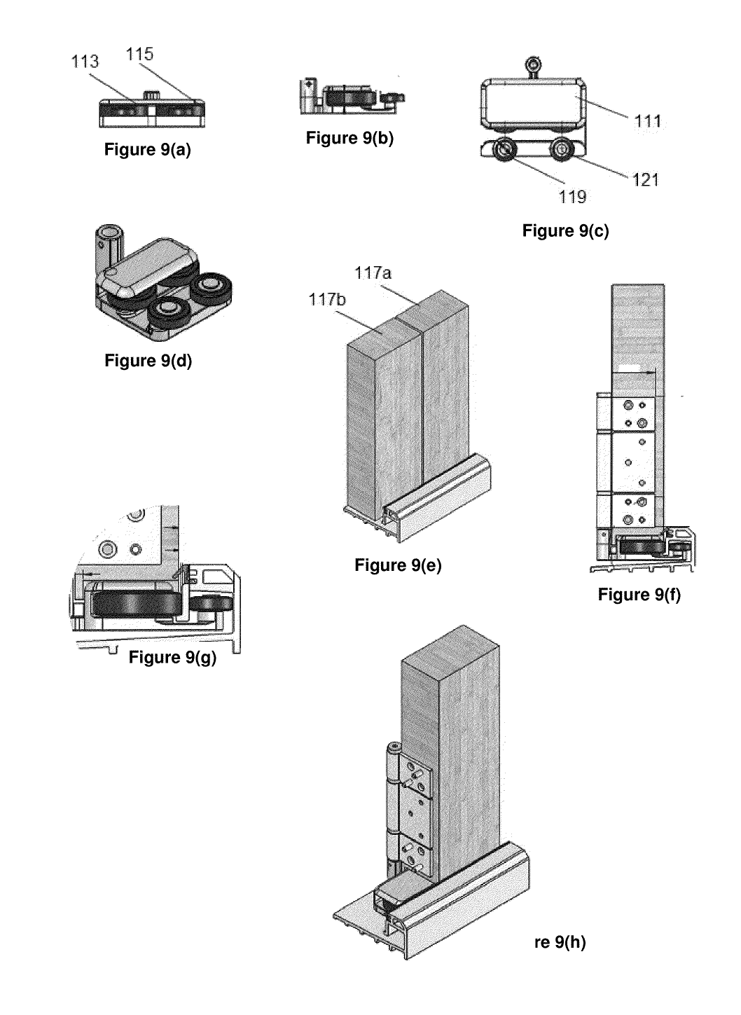

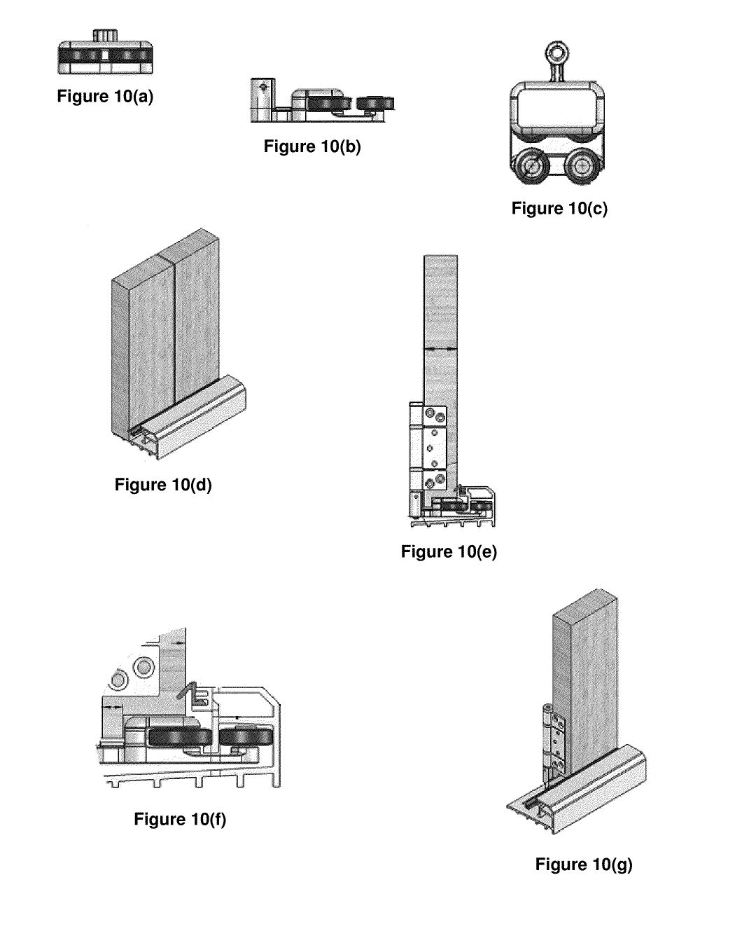

FIGS. 7 to 10 illustrate various embodiments of the lower support alone, and in combination with the track and the panel of a rolling closure. In particular, according to various embodiments of the present invention, both the load wheel(s) and guide wheel(s) may be received and substantially enclosed within the track. Furthermore in other embodiments of the present invention, the track in combination with the panel together substantially enclose both the load wheel(s) and guide wheel(s). Thus the lower closure is protected from dirt and water either by the track or the track in combination with the panel.

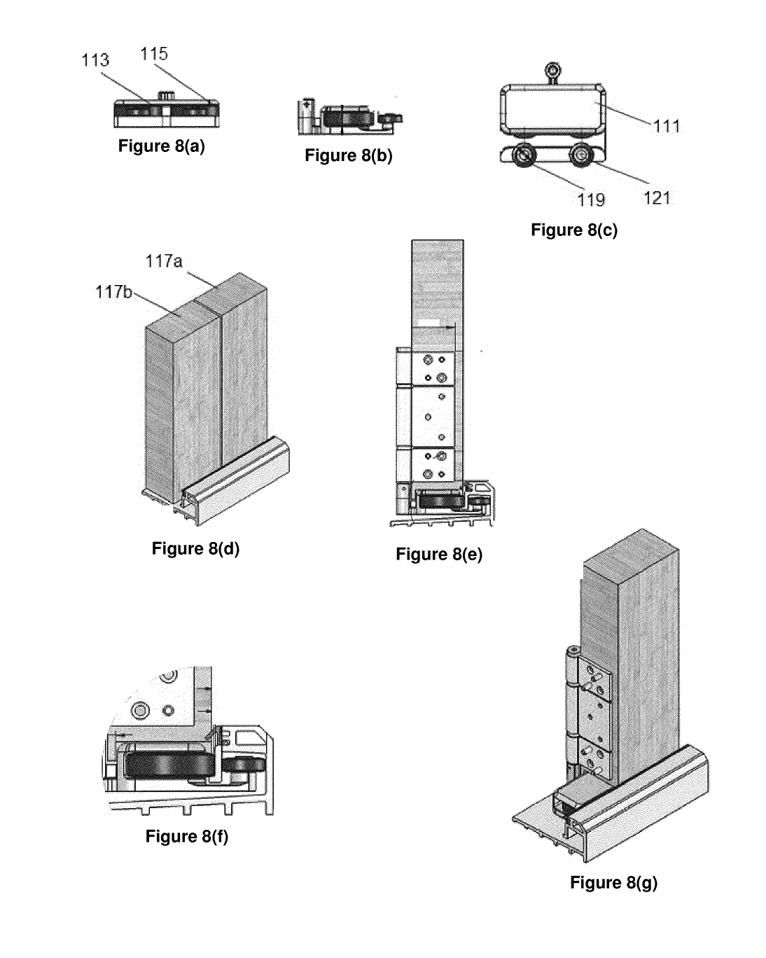

For example FIG. 7 depicts a carriage (111) having load wheels (113, 115) which in use are located adjacent the panel (117) of a rolling closure. The guide wheels (119, 121) are substantially enclosed by the track (123). A weather seal (125) in the form of a rubber fin is located intermediate the panel (117) and track (123) to further protect the carriage from dirt and moisture ingress. FIGS. 8, 9 and 10 depict conformations similar to that of FIG. 7, each including two closure panels (117a, 117b) that contribute to completely enclosing the load wheels (113, 115).

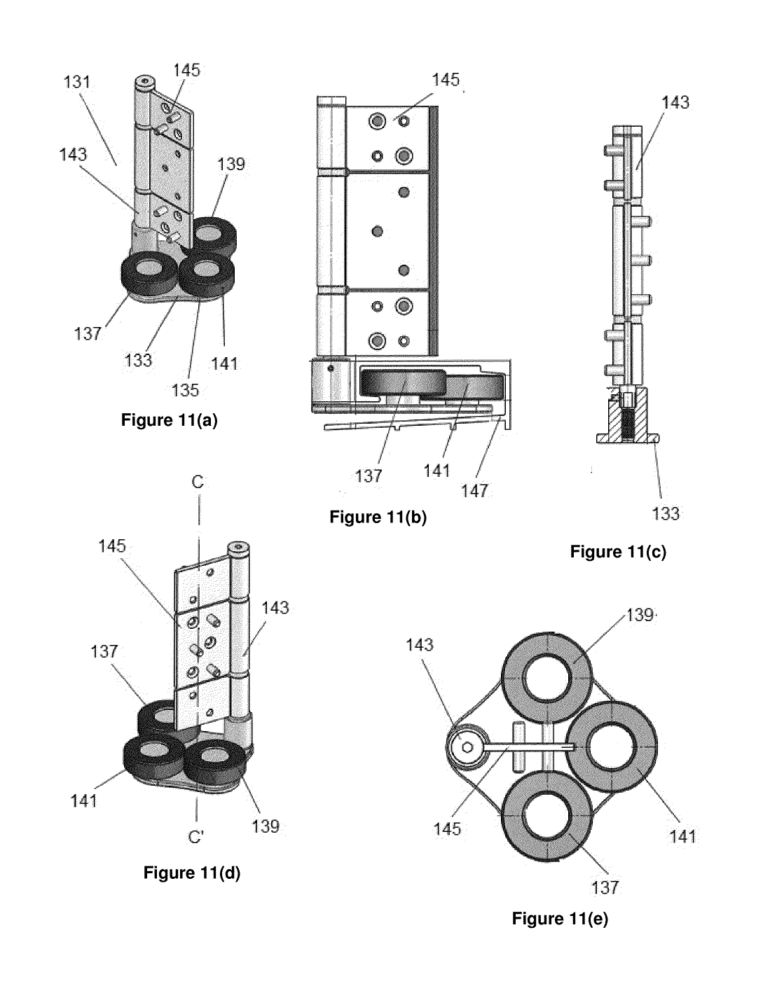

FIG. 11 is a further illustration of a lower support (131) including a carriage (133) comprising a flat plate (135) supporting two load wheels (137, 139) and a guide wheel (141). The carriage (133) connects with a vertical support (143) or pin of a hinge (145) for attachment to the lower part of a panel of a rolling closure. The track (147) substantially encloses the two load wheels (137, 139) and a guide wheel (141) in a manner similar to that shown in FIGS. 5 and 6.

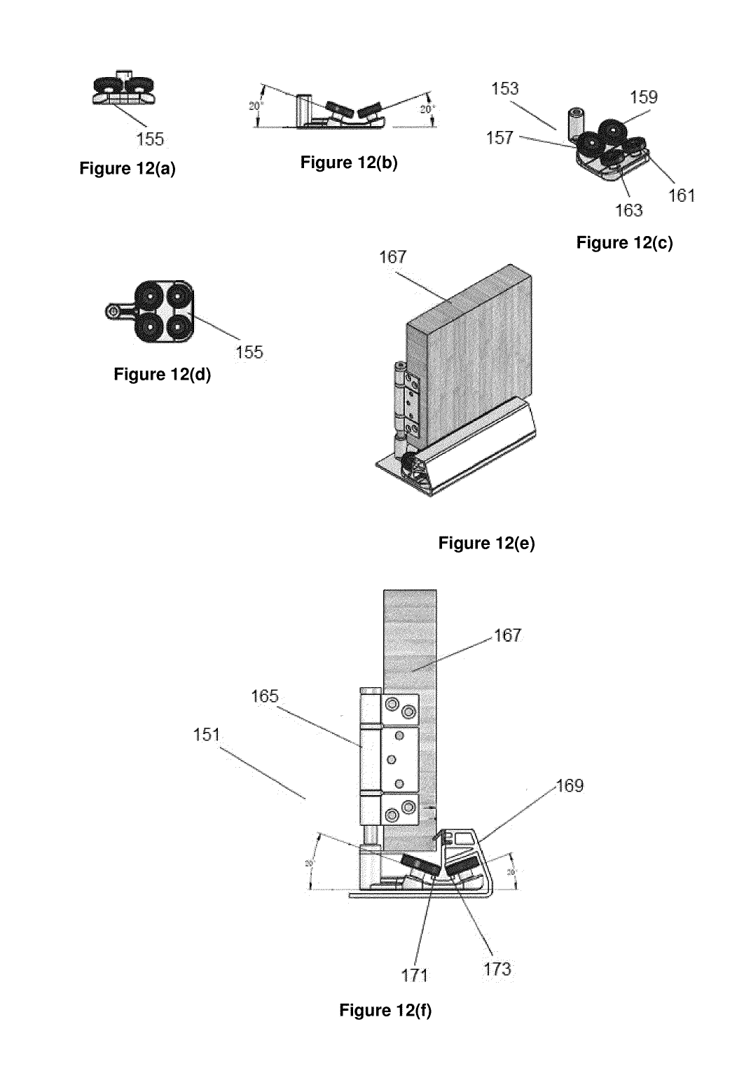

FIG. 12 is a further illustration of a lower support (151) that includes a carriage (153). The carriage comprises a support plate (155) on which is mounted two load wheels (157, 159) and two guide wheels (161, 163). In this embodiment the support plate (155) is configured such that the carriage wheels are mounted at an angle of 20° to the horizontal. The carriage (153) connects with a hinge (165) located to the lower part of a panel (167) of a rolling closure. The track (169) substantially encloses the guide wheels (161, 163), while the panel (167) in combination with the track (169) encloses the load wheels (157, 159). The carriage wheels, include an inclined rim, to minimise the surface area on which the wheels roll. Furthermore, the surfaces (171, 173) of the track which contact the rims are inclined from the horizontal.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A lower support for a rolling closure comprising:
a carriage for supporting a panel of the closure having
at least one horizontal load wheel having an inclined rim, and
at least one horizontal guide wheel,
wherein at least one of the wheels is adapted to be substantially enclosed within a track.

2. A lower support for a rolling closure according to claim 1 wherein at least one horizontal load wheel and at least one horizontal guide wheel is adapted to be substantially enclosed within a track.

3. A track for a lower support of a rolling closure comprising:
a base in connection with a substantially vertical first side wall,
an upper wall in connection with the first side wall, and
a substantially vertical second side wall in connection with the upper wall, the base and walls defining a recess for receiving at least one wheel of a carriage.

4. A track for a lower support of a rolling closure according to claim 3 which further includes at least one inclined surface for receiving an inclined rim of at least one carriage wheel.

5. A system for supporting a rolling closure, the system comprising a lower support according to claim 1 in combination with a track according to claim 3.

6. A rolling closure comprising at least one panel and a lower support according to claim 1.

7. A rolling closure comprising at least one panel and a track according to claim 3.

8. A rolling closure comprising at least one panel and supported by a system according to claim 5.

9. A method of supporting a rolling closure from its lower aspect, the method comprising:
providing a carriage having at least one load bearing wheel and at least one guide wheel,
providing at least one inclined surface, the inclined surface cooperating with the least one of the aforesaid wheels,
wherein the angle between the plane of the load wheel and the horizontal is up to 45°.

10. A method according to claim 9 wherein the angle between the plane of the load wheel and the horizontal is between 4 and 7°.

11. An apparatus when used to carry out the aforesaid method, the apparatus comprising:
a lower support for a panel, the lower support including a carriage having at least one load bearing wheel and at least one guide wheel,
a track including at least one inclined surface for cooperating with at least one of the aforesaid wheels,
wherein the angle between the at least one aforesaid wheel and the horizontal is up to 45°.

12. A lower support for a rolling closure according to claim 1 and substantially as herein described with reference to the drawings.

13. A track for a lower support of a rolling closure according to claim 3 and substantially as herein described with reference to the drawings.
